(19) United States
(12) Patent Application Publication
(10) Pub. No.: US 2026/0289878 A1
(43) Pub. Date: Sep. 24, 2026

(54) SYSTEM AND METHOD FOR PROJECTING SYNTHETIC NODULES IN MEDICAL IMAGING

(71) Applicant: Qure.ai Technologies Private Limited, Mumbai, Maharashtra (IN)

(72) Inventors: Bhargava Reddy, Mumbai, Maharashtra (IN); Preetham Putha, Mumbai, Maharashtra (IN); Pranav Rao, Mumbai, Maharashtra (IN); Ashish Mittal, Mumbai, Maharashtra (IN); Aryan Goyal, Mumbai, Maharashtra (IN); Shreshtha Singh, Mumbai, Maharashtra (IN); Rohitashva Agrawal, Mumbai, Maharashtra (IN); Manoj Tadepalli, Mumbai, Maharashtra (IN)

(21) Appl. No.: 19/449,522

(22) Filed: Jan. 15, 2026

(30) Foreign Application Priority Data
Mar. 18, 2025 (IN) 202521024259

(51) Int. Cl. G06T 12/30; G06T 3/4046; G06T 3/4053; G06T 7/00; G06T 7/11; G06T 11/10; G06T 12/20

(52) U.S. Cl. CPC G06T 12/30; G06T 3/4046; G06T 3/4053; G06T 7/0012; G06T 7/11; G06T 11/10; G06T 12/20; G06T 2207/10081; G06T 2207/20036; G06T 2207/20081; G06T 2207/20084; G06T 2207/30064; G06T 2210/41; G06T 2211/441

(57) ABSTRACT

The present subject matter relates to a system (100) and a method (300) for projecting synthetic nodules in medical imaging. The system (100) receives one or more computed tomography (CT) images and pre-processes the one or more CT images to enhance image quality. The system (100) identifies one or more locations within the pre-processed CT images for placement of the one or more synthetic nodules. Further, the system (100) generates the one or more synthetic nodules and places the one or more synthetic nodules at the identified locations. The system (100) projects the one or more CT images with the placed synthetic nodules to an X-ray image. Further, a style transfer model is applied to the projected X-ray image to generate a realistic X-ray image. Overall, the system (100) enables the creation of high-quality training datasets for early-stage lung cancer, or any lung disease detection.

### CROSS-REFERENCE TO RELATED APPLICATIONS AND PRIORITY

The present application claims priority from Indian Patent Application no. 202521024259 filed on 18^{th} March 2025.

### FIELD OF INVENTION

The presently disclosed embodiments are related, in general, to the field of image processing. More particularly, the presently disclosed embodiments are related to a system and a method for projecting synthetic nodules in medical imaging.

### BACKGROUND OF THE INVENTION

This section is intended to introduce the reader to various aspects of art, which may be related to various aspects of the present disclosure that are described or claimed below. This discussion is believed to be helpful in providing the reader with background information to facilitate a better understanding of the various aspects of the present disclosure. Accordingly, it should be understood that these statements in this background section are to be read in this light, and not as admissions of prior art. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

The technical field of the invention pertains to the identification of pulmonary nodules in chest X-ray images for early-stage cancer detection using machine learning models. Pulmonary nodules, which can be indicative of early-stage lung cancer, or any lung disease require precise identification to facilitate timely diagnosis and treatment. However, several challenges hinder the effective implementation of machine learning models for this task, particularly due to limitations in available datasets and the inherent complexities of X-ray imaging.

A major challenge in developing an accurate machine learning model for pulmonary nodule detection is the scarcity of relevant X-ray and CT image datasets. Machine learning algorithms require large, diverse, and high-quality annotated datasets for training and validation. However, obtaining such datasets is difficult due to multiple factors, including limited access to annotated medical images, ethical concerns surrounding patient data privacy, and the high cost of manual annotation by radiologists. The variability in imaging techniques and equipment further exacerbates the challenge, leading to inconsistent datasets that reduce the generalizability and robustness of AI models. The lack of extensive, standardized datasets significantly affects model performance, increasing the likelihood of false negatives or false positives in clinical applications.

Another critical challenge stems from the two-dimensional (2D) projection nature of X-ray images, which inherently limits the ability to accurately detect pulmonary nodules. Unlike CT scans, which provide detailed 3D imaging of lung structures, X-rays offer a flattened view of anatomical features, leading to several detection difficulties. Small nodules may be imperceptible due to low contrast or may be obscured by overlapping structures such as ribs, heart, or diaphragm. Additionally, due to the loss of depth information, it is often difficult to determine the exact size, shape, and location of nodules, particularly those hidden behind dense anatomical regions or which are impossible to detect using human eyes. This limitation contributes to a high rate of missed detections, making early-stage cancer diagnosis challenging.

Even when nodules are detected, accurate classification of nodule characteristics remains an evolving challenge. Pulmonary nodules exhibit variations in size, shape, texture, and margins, which are crucial for assessing malignancy risk. However, due to the inherent limitations of X-ray imaging, capturing the nodule characteristics with sufficient precision is difficult. The nodules often appear as faint opacities, making it challenging to differentiate between malignant and benign formations. Furthermore, benign lesions such as calcifications, scars, or infections can closely resemble cancerous nodules, increasing the likelihood of false positives.

The absence of volumetric and density information in X-rays further complicates the classification process, necessitating additional diagnostic steps, such as CT imaging or biopsy, to confirm malignancy.

These limitations collectively impact the effectiveness of AI-driven pulmonary nodule detection systems. The lack of a comprehensive training dataset reduces model accuracy, while the constraints of 2D imaging hinder reliable detection and classification. As a result, many AI-based solutions struggle to achieve clinical-grade performance, necessitating further advancements in dataset augmentation, synthetic data generation, and novel machine learning techniques to overcome these challenges and improve early-stage lung cancer detection, or any lung disease.

In light of the above discussion, there exists a need for an improved system and a method for projecting synthetic nodules in medical imaging.

### SUMMARY OF THE INVENTION

Before the present system and device and its components are summarized, it is to be understood that this disclosure is not limited to the system and its arrangement as described, as there can be multiple possible embodiments which are not expressly illustrated in the present disclosure. The present disclosure overcomes one or more shortcomings of the prior art and provides additional advantages discussed throughout the present disclosure. Additional features and advantages are realized through the techniques of the present disclosure. It is also to be understood that the terminology used in the description is for the purpose of describing the versions or embodiments only and is not intended to limit the scope of the present application. This summary is not intended to identify essential features of the claimed subject matter nor is it intended for use in detecting or limiting the scope of the claimed subject matter.

According to embodiments illustrated herein, a method for projecting synthetic nodules in medical imaging is disclosed. In one implementation of the present disclosure, the method may involve various steps performed by a processor. The method may involve a step of receiving one or more computed tomography (CT) images. Further, the method may involve a step of pre-processing the one or more CT images. Furthermore, the method may involve a step of identifying one or more locations within the one or more pre-processed CT images, for placements of the one or more synthetic nodules. Further, the method may involve a step of generating the one or more synthetic nodules on the identified one or more locations. Moreover, the method may involve a step projecting the one or more synthetic nodules, placed on the pre-processed CT image, to a X-ray image. In an embodiment, a realistic X-ray image is generated from the projected X-ray image using a style transfer model.

According to embodiments illustrated herein, a system for projecting the synthetic nodules in the medical imaging is disclosed. In one implementation of the present disclosure, the system may involve the processor and a memory. The memory is communicatively coupled to the processor. Further, the processor may be configured to receive the one or more computed tomography (CT) images. Furthermore, the processor may be configured to pre-process the one or more CT images. Furthermore, the processor may be configured to identify the one or more locations within the one or more pre-processed CT images, for the placements of the one or more synthetic nodules. Further, the processor may be configured to generate the one or more synthetic nodules on the identified one or more locations. Moreover, the processor may be configured to project the one or more synthetic nodules, placed on the pre-processed CT image, to the X-ray image. In an embodiment, the realistic X-ray image is generated from the projected X-ray image using the style transfer model.

According to embodiments illustrated herein, there is provided a non-transitory computer-readable storage medium having stored thereon, a set of computer-executable instructions causing a computer comprising one or more processors to perform various steps. The steps may involve receiving the one or more computed tomography (CT) images. Further, the steps may involve pre-processing the one or more CT images. Furthermore, the steps may involve identifying the one or more locations within the one or more pre-processed CT images, for the placements of the one or more synthetic nodules. Furthermore, the steps may involve generating the one or more synthetic nodules on the identified one or more locations. Moreover, the steps may involve projecting the one or more synthetic nodules, placed on the pre-processed CT image, to the X-ray image. In an embodiment, the realistic X-ray image is generated from the projected X-ray image using the style transfer model.

The foregoing summary is illustrative only and is not intended to be in any way limiting. In addition to the illustrative aspects, embodiments, examples, and features described above, further aspects, embodiments, and features will become apparent by reference to the drawings and the following detailed description.

### BRIEF DESCRIPTION OF DRAWINGS

The detailed description is described with reference to the accompanying figures. In the figures, same numbers are used throughout the drawings to refer like features and components. Embodiments of a present disclosure will now be described, with reference to the following diagrams below wherein:

FIG. 1 illustrates a block diagram describing a system (100) for projecting synthetic nodules in medical imaging, in accordance with at least one embodiment of present subject matter.

FIG. 2 illustrates a block diagram showing an overview of various components of an application server (101) configured for projecting synthetic nodules in the medical imaging, in accordance with at least one embodiment of present subject matter.

FIG. 3 illustrates a flowchart describing a method (300) for projecting synthetic nodules in the medical imaging, in accordance with at least one embodiment of present subject matter.

FIG. 4 illustrates a block diagram (400) of an exemplary computer system (401) for implementing embodiments consistent with the present subject matter.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION OF THE INVENTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the features, structures or characteristics may be combined in any suitable manner in one or more embodiments.

The words "comprising," "having," "containing," and "including," and other forms thereof, are intended to be equivalent in meaning and be open ended in that an item or items following any one of these words is not meant to be an exhaustive listing of such item or items or meant to be limited to only the listed item or items. It must also be noted that, the singular forms "a," "an," and "the" include plural references unless the context clearly dictates otherwise. Although any methods similar or equivalent to those described herein can be used in the practice or testing of embodiments of the present disclosure, the exemplary methods are described. The disclosed embodiments are merely exemplary of the disclosure, which may be embodied in various forms.

The terminology “one or more computed tomography (CT) images” and “CT images” has the same meaning and are used alternatively throughout the specification. Further, the terminology “one or more synthetic nodules”, “synthetic nodules”, and “nodules” has the same meaning and are used alternatively throughout the specification. Furthermore, the terminology “one or more locations” and “locations” has the same meaning and are used alternatively throughout the specification. Furthermore, the terminology “style transfer model” and “style transfer technique” has the same meaning and are used alternatively throughout the specification.

The present disclosure relates to a system for projecting synthetic nodules in medical imaging. The system includes a processor and a memory storing instructions that enable the processor to receive one or more computed tomography (CT) images. Further, the system may pre-process the one or more CT images. Furthermore, the system may identify one or more locations within the one or more pre-processed CT images, for placements of the one or more synthetic nodules. Further, the system may generate the one or more synthetic nodules on the identified one or more locations. Moreover, the system may project the one or more synthetic nodules, placed on the pre-processed CT image, to an X-ray image. In an embodiment, a realistic X-ray image may be generated from the projected X-ray image using a style transfer model. This approach enhances the medical imaging by automating the generation and projection of the synthetic nodules, ensuring realistic and diagnostically valuable X-ray images. By leveraging the computed tomography (CT) images and the style transfer model, the system optimizes the creation of high-fidelity training datasets, improving AI-driven nodule detection. This enables scalable and efficient augmentation of the medical imaging data, supporting more accurate and robust diagnostic tools.

To address the challenges of the synthetic nodule generation and the projection in medical imaging, the disclosed system integrates an automated approach using computational modeling and the style transfer model. The system continuously processes the computed tomography (CT) images, applies the conditions to identify a nodule placement locations and dynamically generates the synthetic nodules with configurable attributes. These synthetic nodules are then projected onto the X-ray images using ray-tracing and attenuation modeling techniques. By automating these processes, the system reduces manual intervention and enhances the realism of the generated X-ray images. The continuous processing mechanism ensures that the synthetic nodules are accurately placed and projected in real time, enabling seamless and high-throughput augmentation of the medical imaging datasets. This approach improves diagnostic training, supports AI-based detection models, and ensures scalable, efficient, and clinically relevant data generation.

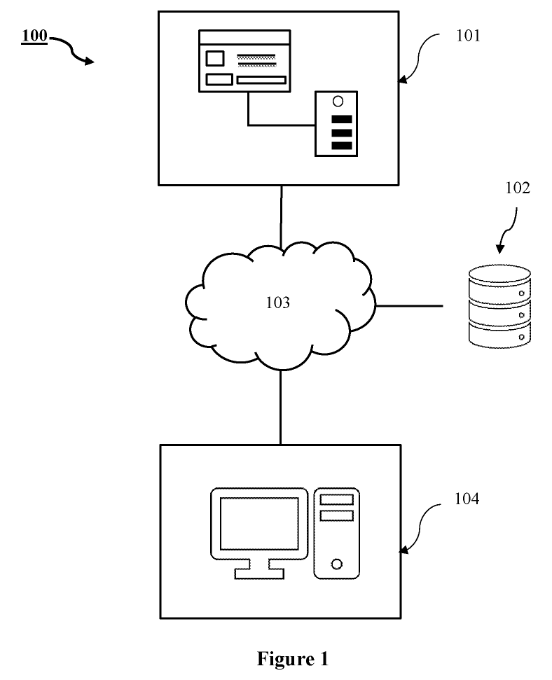

Referring to FIG. 1 is a block diagram that illustrates the system (100) for projecting the one or more synthetic nodules in the medical imaging, in accordance with at least one embodiment of the present subject matter. The system (100) typically comprises an application server (101), a database server (102), a communication network (103), and a user computing device (104). The application server (101), the database server (102), and the user computing device (104) are typically communicatively coupled with each other via the communication network (103). In an embodiment, the application server (101) may communicate with the database server (102), and the user computing device (104) using one or more protocols such as, but not limited to, Hypertext Transfer Protocol (HTTP), Transmission Control Protocol/Internet Protocol (TCP/IP), Wireless Application Protocol (WAP), RF mesh, Bluetooth Low Energy (BLE), and the like, to communicate with one another.

In an embodiment, the database server (102) may refer to a computing device that is configured to store and manage large volumes of medical imaging data, including synthetic nodule projections, within memory (202). The database server (102) may enable efficient data retrieval, processing, and storage operations essential for diagnostic analysis and model training. The database server (102) may include a centralized repository specifically designed to perform one or more database operations on data received from the application server (101) and the user computing device (104). In an embodiment, the database server (102) includes a centralized repository specifically configured to receive, pre-process, identify, generate, and project the generated synthetic nodules on the X-ray image. In an exemplary embodiment, the centralized repository may also store data, including application-specific configurations, AI model-generated insights, annotation logs, and computed attenuation parameters for synthetic nodules. The centralized repository is further configured to execute one or more database operations, providing secure and optimized access to imaging and diagnostic data for system components interacting within the network. Further, the centralized repository is configured to execute database operations such as searching, scanning, identifying, and retrieving the one or more locations within the one or more pre-processed CT images. In an embodiment, the database server (102) may include specialized hardware and software configurations that are optimized for real-time processing of medical images and projecting the generated synthetic nodules on the X-ray images. In an exemplary embodiment, the database server (102) may be realized through various database technologies such as, but not limited to, relational database systems, distributed database architectures, cloud-based database management systems, and NoSQL databases. In an embodiment, the database server (102) may be configured to interact with the application server (101) to facilitate data-driven decision-making processes, support analytical computations, and ensure efficient data storage and retrieval mechanisms. In an exemplary embodiment, the database server (102) helps maintain data integrity, ensure secure access control, and enable real-time updates for projecting the synthetic nodules in the identified locations within the system (100).

A person with ordinary skills in art will understand that the scope of the disclosure is not limited to the database server (102) as a separate entity. In an embodiment, the functionalities of the database server (102) can be integrated into the application server (101) or into the user computing device (104).

In an embodiment, the application server (101) may refer to a computing device or a software framework hosting an application or a software service. In an embodiment, the application server (101) may be implemented to execute procedures such as, but not limited to, programs, routines, or scripts stored in the database server (102) for supporting the hosted application or the software service. In an embodiment, the hosted application or the software service may be configured to perform one or more predetermined operations. The application server (101) may be realized through various types of application servers such as, but are not limited to, a Java application server, a .NET framework application server, a Base4 application server, a PHP framework application server, or any other application server framework.

In an embodiment, the application server (101) may be configured to manage and coordinate the flow of data between the database server (102), the user computing device (104), and the AI-based inference engines within the system (100). The application server (101) is a computing system that processes synthetic nodule projection, facilitates model inference operations, and ensures seamless data transmission for diagnostic analysis and model training. The application server (101) may retrieve synthetic and real-world medical imaging data from the database server (102) and apply a CT-to-X-ray projection to enhance image quality, standardize formats, and ensure compliance with imaging protocols. The application server (101) may interact with AI-based image processing models to generate synthetic X-ray projections, execute style transfer operations, and refine attenuation parameters for the synthetic nodules. Additionally, the application server (101) may be responsible for processing metadata associated with synthetic nodule generation, including nodule texture, shape, and boundary characteristics.

Further, the application server (101) interacts with external AI inference engines and deep learning models to apply the style transfer model, enhancing quality of the synthetic X-ray image.

In an embodiment, the application server (101) may be configured to receive the one or more computed tomography (CT) images.

In an embodiment, the application server (101) may be configured to pre-process the one or more CT images.

In an embodiment, the application server (101) may be configured to identify the one or more locations within the one or more pre-processed CT images, for the placement of the one or more synthetic nodules.

In an embodiment, the application server (101) may be configured to generate the one or more synthetic nodules on the identified one or more locations.

In an embodiment, the application server (101) may be configured to project the one or more synthetic nodules, placed on a pre-processed CT image, to an X-ray image. In an embodiment, the realistic X-ray image may be generated from the projected X-ray image using the style transfer model.

In an embodiment, the communication network (103) may correspond to a communication medium through which the application server (101), the database server (102), and the user computing device (104) may communicate with each other. Such communication may be performed in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), Wireless Application Protocol (WAP), File Transfer Protocol (FTP), ZigBee, EDGE, infrared IR), IEEE 802.11, 802.16, 2G, 3G, 4G, 5G, 6G, 7G cellular communication protocols, and/or Bluetooth (BT) communication protocols. The communication network (103) may either be a dedicated network or a shared network. Further, the communication network (103) may include a variety of network devices, including routers, bridges, servers, computing devices, storage devices, and the like. The communication network (103) may include, but is not limited to, the Internet, intranet, a cloud network, a Wireless Fidelity (Wi-Fi) network, a Wireless Local Area Network (WLAN), a Local Area Network (LAN), a cable network, the wireless network, a telephone network (e.g., Analog, Digital, POTS, PSTN, ISDN, xDSL), a telephone line (POTS), a Metropolitan Area Network (MAN), an electronic positioning network, an X.25 network, an optical network (e.g., PON), a satellite network (e.g., VSAT), a packet-switched network, a circuit-switched network, a public network, a private network, and/or other wired or wireless communications network configured to carry data.

In an embodiment, the user computing device (104) may comprise one or more processors and one or more memory. The one or more memory may include computer-readable instructions that may be executable by one or more processors to perform predetermined operations of the system (100). In an embodiment, the user computing device (104) may present a web user interface to display operations performed by the application server (101). Example web user interfaces presented on the one or more portable devices to display a visualization dashboard which facilitates a task management functionality to one or more users. Examples of the user computing device (104) may include, but are not limited to, a personal computer, a laptop, a personal digital assistant (PDA), a mobile device, a tablet, or any other computing device.

The system (100) can be implemented using hardware, software, or a combination of both, which includes, where suitable, one or more computer programs, web-based applications, or mobile applications deployed either on-premises over the corresponding computing terminals or virtually over cloud infrastructure. The system (100) may include various microservices or independent computing modules that interact seamlessly with other system components. The system (100) may also interface with third-party or external computing systems for data exchange and integration. Internally, the system (100) serves as the central processor, handling requests for projecting the one or more synthetic nodules in medical imaging. A critical attribute of the system (100) is its ability to concurrently and dynamically process the data, interact with the database server (102) and the application server (101), and further facilitate seamless communication with the user computing device (104). In a specific embodiment, the system (100) is implemented for projecting the synthetic nodules in the medical images to generate the realistic X-ray images, enabling early and accurate detection of lung disease.

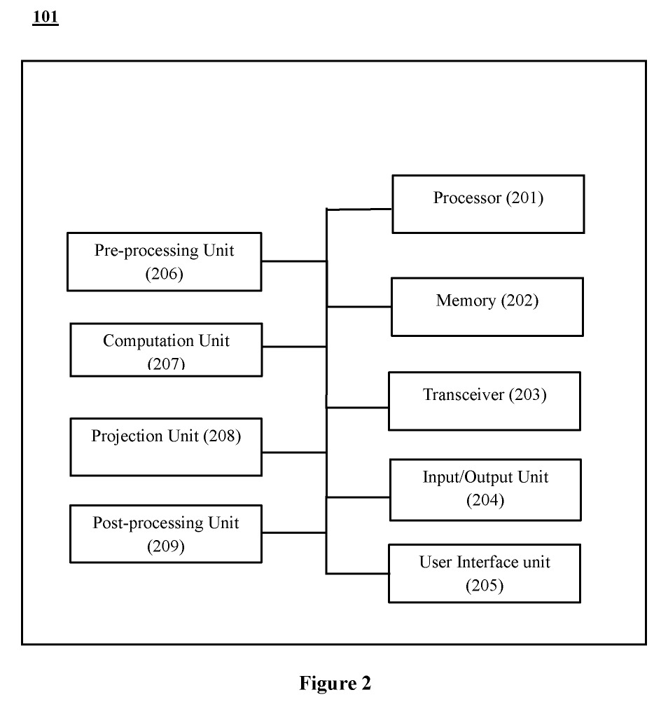

Now referring to FIG. 2, illustrates a block diagram (200) showing an overview of various components of the application server (101) configured for projecting the synthetic nodules in the medical imaging, in accordance with at least one embodiment of the present subject matter. FIG. 2 is explained in conjunction with elements from FIG. 1. In an embodiment, the application server (101) includes a processor (201), a memory (202), a transceiver (203), an input/output unit (204), a user interface unit (205), a pre-processing unit (206), a computation unit (207), a projection unit (208), and a post-processing unit (209). The processor (201) may be communicatively coupled to the memory (202), the transceiver (203), the input/output unit (204), the user interface unit (205), the pre-processing unit (206), the computation unit (207), the projection unit (208), and the post-processing unit (209). The transceiver (203) may be communicatively coupled to the communication network (104) of the system (100).

In an embodiment, the system (100) for projecting the synthetic nodules in the medical imaging is disclosed. The system (100) may receive the one or more computed tomography (CT) images and performs pre-processing to identify anatomical structures while eliminating external artifacts using the deep learning techniques trained on labelled CT scans. Further, the system (100) may include segmenting the CT images into regions and selecting locations for the synthetic nodule placement based on the one or more properties. The synthetic nodules may be generated with configurable parameters, including texture (ground-glass, part-solid, solid, calcified), shape (spherical, ovoid, linear, elongated), and boundary characteristics (diffused, sharp, spiculated, blending). The subtlety of the nodules is controlled based on their location, characteristics, and radiodensity. Once generated, the nodules are projected onto the X-ray image using Beer-Lambert Law of attenuation, producing a Digitally Reconstructed Radiograph (DRR). Further, the system (100) may use the style transfer model to enhance the DRR to generate the realistic X-ray image by adjusting contrast, brightness, resolution, and texture while preserving critical anatomical details such as bronchi, small nodules, and subtle abnormalities.

In another embodiment, the generation of a realistic X-ray image involves a denoising diffusion probabilistic model (DDPM) trained on a dataset of paired high-quality (HQ) real X-rays and low-quality (LQ) CT-to-X-ray projections. The dataset is created using a shared latent space generative adversarial network (GAN) to transform DRRs into high-quality X-ray images and employing a Multimodal Unsupervised Image-to-Image Translation (MUNIT) architecture to maintain anatomical structure during transformations. Additionally, the quality of the input CT images is enhanced through a super-resolution module that processes each 2D slice via the trained model and reconstructs the full 3D CT volume by stacking the 2D slices. The system comprises modules for receiving and pre-processing the CT images, identifying nodule placement locations, generating synthetic nodules, and projecting them onto X-ray images.

The processor (201) comprises suitable logic, circuitry, interfaces, and/or code that may be configured to execute a set of instructions stored in the memory (202) and may be implemented based on several processor technologies known in the art. The processor (201) works in coordination with the memory (202), the transceiver (203), the input/output unit (204), the user interface unit (205), the pre-processing unit (206), the computation unit (207), the projection unit (208), and the post-processing unit (209) for projecting the synthetic nodules in the medical imaging. Examples of the processor (201) include, but not limited to, a standard microprocessor, microcontroller, central processing unit (CPU), an X86-based processor, a Reduced Instruction Set Computing (RISC) processor, an Application- Specific Integrated Circuit (ASIC) processor, and a Complex Instruction Set Computing (CISC) processor, distributed or cloud processing unit, state machines, logic circuitries, and/or any devices that manipulate signals based on operational instructions and/or other processing logic that accommodates the requirements of the present invention.

The memory (202) comprises suitable logic, circuitry, interfaces, and/or code that may be configured to store the set of instructions, which are executed by the processor (201). Preferably, the memory (202) is configured to store one or more programs, routines, or scripts that are executed in coordination with the processor (201). Additionally, the memory (202) may include any computer-readable medium or computer program product known in the art including, for example, volatile memory, such as static random-access memory (SRAM) and dynamic random-access memory (DRAM), and/or non-volatile memory, such as read-only memory (ROM), erasable programmable ROM, a Hard Disk Drive (HDD), flash memories, Secure Digital (SD) card, Solid State Disks (SSD), optical disks, magnetic tapes, memory cards, virtual memory and distributed cloud storage. The memory (202) may be removable, non-removable, or a combination of the same. Further, the memory (202) may include routines, programs, objects, components, data structures, etc., which perform particular tasks or implement particular abstract data types. The memory (202) may include programs or coded instructions that supplement the applications and functions of the system (100). In one embodiment, the memory (202), amongst other things, serves as a repository for storing data processed, received, and generated by one or more of the programs or the coded instructions. In yet another embodiment, the memory (202) may be managed under a federated structure that enables the adaptability and responsiveness of the application server (101).

The transceiver (203) comprises suitable logic, circuitry, interfaces, and/or code that may be configured to receive, process or transmit information, data or signals, which are stored by the memory (202) and executed by the processor (201). The transceiver (203) is preferably configured to receive, process or transmit one or more programs, routines, or scripts that are executed in coordination with the processor (201). The transceiver (203) is preferably communicatively coupled to the communication network (103) of the system (100) for communicating all the information, data, signals, programs, routines or scripts through the communication network (103).

The transceiver (203) may implement one or more known technologies to support wired or wireless communication with the communication network (103). In an embodiment, the transceiver (203) may include but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. Also, the transceiver (203) may communicate via wireless communication with networks, such as the Internet, an Intranet and/or a wireless network, such as a cellular telephone network, a wireless local area network (LAN) and/or a metropolitan area network (MAN). Accordingly, the wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The input/output (I/O) unit (204) comprises suitable logic, circuitry, interfaces, and/or code that may be configured to receive or present information. The input/output unit (204) comprises various input and output devices that are configured to communicate with the processor (201). Examples of the input devices include but are not limited to, a keyboard, a mouse, a joystick, a touch screen, a microphone, a camera, and/or a docking station. Examples of the output devices include, but are not limited to, a display screen and/or a speaker. The I/O unit (204) may include a variety of software and hardware interfaces, for example, a web interface, a graphical user interface, and the like. The I/O unit (204) may allow the system (100) to interact with the user directly or through the user computing devices (104). Further, the I/O unit (204) may enable the system (100) to communicate with other computing devices, such as web servers and external data servers (not shown). The I/O unit (204) can facilitate multiple communications within a wide variety of networks and protocol types, including wired networks, for example, LAN, cable, etc., and wireless networks, such as WLAN, cellular, or satellite. The I/O unit (204) may include one or more ports for connecting a number of devices to one another or to another server. In one embodiment, the I/O unit (204) allows the application server (101) to be logically coupled to other user computing devices (104), some of which may be built in. Illustrative components include tablets, mobile phones, wireless devices, etc.

Further, the input/output (I/O) unit (204) may be configured to facilitate interaction between the system (100) and the user by providing data access and operational controls. In an embodiment, the I/O unit (204) enables real-time monitoring and control of the synthetic nodule generation, projection, and the style transfer techniques performed by the system. The I/O unit (204) may be configured to display system status, execution logs, and processing details through a user interface (205). Further, the I/O unit (204) may be configured to receive the one or more computed tomography (CT) images through the user interface (205). In an exemplary embodiment, the I/O unit (204) may provide a visualization dashboard to the user, indicating the status of CT image pre-processing, segmentation of anatomical structures, placement of synthetic nodules, and projection of the nodules to the X-ray image. The visualization dashboard may further display batch execution details, confidence scores of voxel segmentation, and real-time updates on the synthetic nodule characteristics, including the texture, shape, and boundary attributes. The visualization dashboard may also include synthetic nodule insertions, processing metrics for the deep learning models, system alerts, and performance analytics related to the generation of the Digitally Reconstructed Radiographs (DRRs) and the application of the style transfer model. Additionally, the I/O unit (204) may facilitate workflow management by displaying pending, in-progress, and completed synthetic nodule projection tasks, along with diagnostic quality enhancement operations performed on the projected X-ray images.

Further, the user interface unit (205) may facilitate interaction between the user and the application server (101) by enabling the transmission of user inputs for projecting the synthetic nodules on the medical imaging. The application server (101) processes the received inputs by initiating the generation of the synthetic nodules within the CT scan image, configuring the nodule characteristics such as the texture, the shape, and the boundary attributes, and dynamically adjusting the projection parameters based on the real-time processing requirements. The system further processes the CT-to-X-ray projection using the ray-tracing techniques to simulate attenuation effects, followed by the application of the style transfer model to enhance the diagnostic realism of the X-ray image. The user interface unit (205) may further facilitate the retrieval and presentation of processed results to the user by enabling real-time updates on the generated X-ray projections, including detailed overlays comparing the synthetic and real nodules, confidence scores for anatomical consistency, and diagnostic quality metrics. The user interface unit (205) may also provide interactive controls for fine-tuning the synthetic nodule generation parameters and visualizing the projected X-ray images.

Further, the pre-processing unit (206) may be configured to process the one or more CT images to identify the anatomical body structures and eliminate external artifacts for efficient image analysis. In an embodiment, the pre-processing of the one or more CT images may be performed using one or more deep learning techniques. In an embodiment, the one or more deep learning techniques may include at least one of a ResNet-based encoder-decoder architecture or a Unet-based segmentation model, both built with convolutional neural networks (CNNs), or the combination of the same.

In an exemplary embodiment, the one or more deep learning techniques may be trained on a plurality of labeled CT scans with annotated lung masks to ensure the accurate segmentation. The deep learning model may be trained on an internal dataset consisting of the input of the CT images and corresponding output lung segmentation masks. The segmentation process may generate a refined mask for identifying the lung structures, which serves as an essential input for the subsequent artifact removal steps.

Additionally, the pre-processing unit (206) may be configured to remove the external artifacts from the one or more CT images. In an embodiment, the segmentation mask generated by the aforementioned deep learning model may be utilized along with CT windowing techniques, flood fill algorithms, morphological operations such as erosion and dilation, and other image processing methods to determine the region capturing the patient’s body. The system may remove external artifacts such as imaging beds and machine components, thereby enhancing the quality and accuracy of the processed CT images. The algorithms may utilize windowing to detect relevant anatomical structures such as soft tissue, lungs, and bones, thereby generating a body mask that accurately represents the patient’s anatomy.

Further, the computation unit (207) may be configured to identify the one or more locations within the one or more pre-processed CT images for the placement of one or more synthetic nodules. In an embodiment, the identification of the one or more locations may be performed by utilizing the one or more deep learning techniques to predict the one or more voxels from the plurality of voxels in the one or more CT images. Further, each of the one or more voxels may be associated with the confidence score indicating the probability of the voxel belonging to the lung region within the one or more CT images. The computation unit (207) may further ensure accurate localization of the lung regions by leveraging probability-based voxel classification, thereby optimizing segmentation accuracy and enhancing the reliability of nodule placement.

In another embodiment, the computation unit (207) may convert the probability of each voxel into a binary mask using one or more image processing techniques. The one or more image processing techniques may include at least one of thresholding, morphological operations, dilation, erosion, opening, closing, or a combination thereof. These techniques aid in refining segmentation results and eliminating noise, thereby improving the precision of lung region detection. Additionally, the computation unit (207) may refine the binary mask corresponding to each of the one or more voxels by applying morphological operations, ensuring the removal of small, erroneous regions.

Further, the computation unit (207) may be configured to extract a pair of connected voxels from the one or more voxels, indicating segmentation of the left and right lungs. The computation unit (207) may calculate the volume of the connected regions in the binary mask and apply thresholding on the calculated values to remove spurious small regions that may have been generated erroneously. This step ensures that only meaningful lung regions are considered for further processing, thereby reducing false positives in segmentation.

Additionally, the computation unit (207) may be configured to segment each of the one or more pre-processed CT images into one or more regions and generate location proposals based on the one or more properties. These properties may include, but are not limited to, anatomical body structures, lung segmentation boundaries, and spatial constraints, ensuring optimal placement of synthetic nodules within the identified regions. The computation unit (207) may ensure precise segmentation and placement of the synthetic nodules by leveraging deep learning-based region identification, thereby enhancing the quality and accuracy of the synthetic training data generation. Further, the location proposals may be generated based on configurable parameters that define the placement and size of synthetic nodules. In an exemplary embodiment, the configurable location parameters may include pleura, apex, hilar, diaphragm, and occlusion by bone, among others. In an exemplary embodiment, the size parameter may range from 1 mm to 30 mm. For example, if the location parameter is set to the diaphragm and the size parameter is 5 mm, the algorithm will generate a location proposal within the lower segment of the lung, near the diaphragm, with a spherical shape and a diameter of 5 mm.

The computation unit (208) may be configured to generate the one or more synthetic nodules at the identified locations. The synthetic nodules may be generated with configurable characteristics such as texture, shape, and boundary definition. In an exemplary embodiment, the one or more parameters may include at least one of texture, shape, nodule boundary, or a combination thereof. The texture parameter within each synthetic nodule may be obtained through utilizing one or more noise distribution techniques reflecting real-world nodule patterns. The texture parameters may include one of ground-glass (GGN), part-solid, solid, calcified textures, or a combination thereof. The shape parameter may include one of spherical, ovoid, linear, elongated, or a combination thereof. The nodule boundary parameter within each synthetic nodule may be obtained through utilizing one or more image processing techniques. The nodule boundary parameter may include at least one of diffused boundary, sharp boundary, spiculated boundary, blending boundary, or a combination thereof. The generation process may ensure realistic synthesis by adjusting the subtlety of nodules based on their location, characteristics, and radiodensity, thereby preserving anatomical consistency.

The computation unit (208) may further include a body segmentation process that utilizes connected voxels to generate the body segmentation mask. The segmentation process may iteratively identify the neighboring voxels based on at least one of the predefined intensity window, three-dimensional (3D) connectivity using a kernel, or a combination thereof. The predefined intensity window may correspond to a Hounsfield unit (HU) range of -500 HU to 2000 HU, indicating at least one of soft tissues, bones, or a combination of the same. The segmentation process may further involve removing small or disconnected voxels, which may represent regions outside the main body, and applying morphological operations to smoothen the edges of the segmentation mask.

The computation unit (208) may be configured to multiply the body segmentation mask with the original CT image using the one or more deep learning techniques. This multiplication process may retain the anatomical body structures while eliminating the external artifacts. The multiplication process may further ensure that the resulting CT image maintains an accurate anatomical representation, improving the quality and reliability of the synthetic nodule projection.

The computation unit (208) may be further configured to generate a realistic X-ray image from a projected X-ray image using a denoising diffusion probabilistic model (DDPM). The DDPM may be trained on a dataset to refine and enhance the projected X-ray image by improving its contrast, brightness, resolution, texture, and noise reduction. The enhancement process may enable the generation of the high-quality X-ray images with diagnostic-level clarity. In an embodiment, the computation unit (208) may include an algorithm for body segmentation that defines an intensity window corresponding to soft tissue and bone structures. The algorithm may utilizethe lung mask as a seed region and apply connected component analysis to iteratively identify and include neighboring voxels within the predefined intensity range. The process may remove small, disconnected regions and smoothen the edges using morphological operations. The final segmentation mask may be used to reconstruct the complete 3D CT volume by stacking the enhanced 2D slices. Noise-reduction techniques may be applied to counteract artifacts such as beam starvation, streaking, and Gaussian noise, thereby enhancing the signal-to-noise ratio while preserving anatomical details.

The computation unit (208) may further generate realistic X-ray images using the style transfer model. The style transfer model may involve training on a dataset of paired high-quality (HQ) real X-rays and low-quality (LQ) digitally reconstructed radiographs (DRRs). The transformation may be approached as a domain adaptation problem, utilizing a shared latent space generative adversarial network (GAN) and a Multimodal Unsupervised Image-to-Image Translation (MUNIT) architecture. The MUNIT model may learn the shared latent space between DRRs and real X-rays, enabling accurate transformations while preserving anatomical structures.

In another embodiment, the computation unit (208) may train an enhancement diffusion model to refine projected X-rays and generate realistic X-ray images. The enhancement model may improve resolution, contrast, and noise reduction while preserving critical anatomical details such as bronchi, small nodules, and subtle abnormalities. The computation unit (208) may further employ a DDPM using the paired dataset to enhance DRRs into high-quality X-rays. The DDPM may be trained to address noise, low contrast, and resolution issues while removing artifacts, ensuring a clear and accurate diagnostic output.

The computation unit (208) may further facilitate the preparation of training data using paired high-quality (HQ) real X-rays and low-quality (LQ) CT-to-X-ray projections. The training data may be prepared by utilizing a shared latent space generative adversarial network (GAN) model to transform the DRRs into high-quality X-ray images. Additionally, the computation unit (208) may employ a Multimodal Unsupervised Image-to-Image Translation (MUNIT) architecture to learn the shared latent space between the DRRs and the real X-ray images, allowing transformations while maintaining anatomical structure. Furthermore, the computation unit (208) may transform real X-ray images into DRR-like images, creating a dataset of paired DRR-like images and the real X-ray images.

The computation unit (208) may employ ray tracing techniques for virtual simulation (VS) of radiotherapy, enabling the generation of Digitally Reconstructed Radiographs. The Beer-Lambert Law of attenuation may be used to calculate the attenuation of X-rays passing through different tissues, while ray tracing may determine the trajectory of said X-rays. The computation unit (208) may analyze rays traveling from a source point to a detector screen by calculating each ray’s attenuation caused by tissues the ray passes through. The X-ray source parameters (such as position, angle, and energy) may be specified for accurate simulation.

The computation unit (208) may perform ray tracing in multiple steps. The computation unit (208) may trace rays along a straight line through the 3D image towards the detector plane. Further, the computation unit (208) may calculate the path of each ray, determining which tissues (such as soft tissue, bone, or nodule) the ray intersects along the way. Furthermore, the computation unit (208) may accumulate attenuation along the ray path by applying the Beer-Lambert Law to each segment of the ray as it passes through different tissues, providing the total amount of attenuation the ray undergoes.

The computation unit (208) may then construct a 2D X-ray projection that accurately simulates anatomical interaction with X-rays. The projection may involve summing the attenuations along all rays contributing to each pixel in the projection plane, creating a "shadow" or darkened region on the 2D image corresponding to higher attenuation. The final 2D projection may be reconstructed by processing multiple rays from various angles around the patient, creating a full X-ray simulation.

Further, the projection unit (208) may be responsible for projecting the one or more synthetic nodules, placed on a pre-processed CT image, to an X-ray image, wherein a realistic X-ray image is generated from the projected X-ray image using a style transfer model.

Further, the projection unit (208) may also be responsible for controlling the subtlety of the one or more synthetic nodules. The controlling of the subtlety may be achieved using a function of at least one of location, nodule characteristics, radiodensity, or a combination thereof.

In another embodiment, the projection unit (208) may project the one or more synthetic nodules to the X-ray image using the Beer-Lambert Law of attenuation. The projection process may correspond to generating a Digitally Reconstructed Radiograph (DRR), ensuring an accurate simulation of anatomical interaction with X-rays.

The post-processing unit (209) may be configured to generate the realistic X-ray image from the projected X-ray image using the style transfer model. Further, the post-processing unit (209) may utilize the style transfer model to enhance the diagnostic quality of the projected X-ray image by adjusting one of contrast, brightness, resolution, texture, reduced noise/artifacts, or a combination thereof, thereby generating a realistic X-ray image while preserving critical anatomical details from one of bronchi, small nodules, subtle abnormalities, or a combination thereof.

Further, the post-processing unit (209) may apply post-processing for brightness and contrast optimization using a custom-trained style transfer model with a specialized algorithm for mimicking the aesthetic and diagnostic quality of traditional X-rays.

Furthermore, the post-processing unit (209) may perform post-processing techniques to refine the segmentation mask. In an embodiment, post-processing steps may include morphological operations such as closing to eliminate small holes or noise from the segmentation output. This ensures that the final processed CT image retains anatomical accuracy while eliminating the external artifacts, optimizing it for downstream medical imaging applications. Additionally, the post-processing techniques may be applied to the 2D digitally reconstructed radiograph (DRR) projection to enhance image quality. These steps collectively ensure that the final processed images are optimized for improved analysis and interpretation. Moreover, the post-processing techniques include, but not limited to, the diffusion model, the MUNIT (GAN based model). In an embodiment, the diffusion model may be trained on paired data generated from the MUNIT (GAN based model) to improve the quality of obtained projections and make the projections visually indistinguishable from the actual X-rays images.

The post-processing unit (209) may also enhance the quality of the one or more CT images through a super-resolution module. The super-resolution module may process each 2D slice of the received 3D CT image through a trained model to predict an enhanced slice. The computation unit (208) may further reconstruct a complete 3D volume based on the enhanced slices, ensuring the high-quality imaging output.

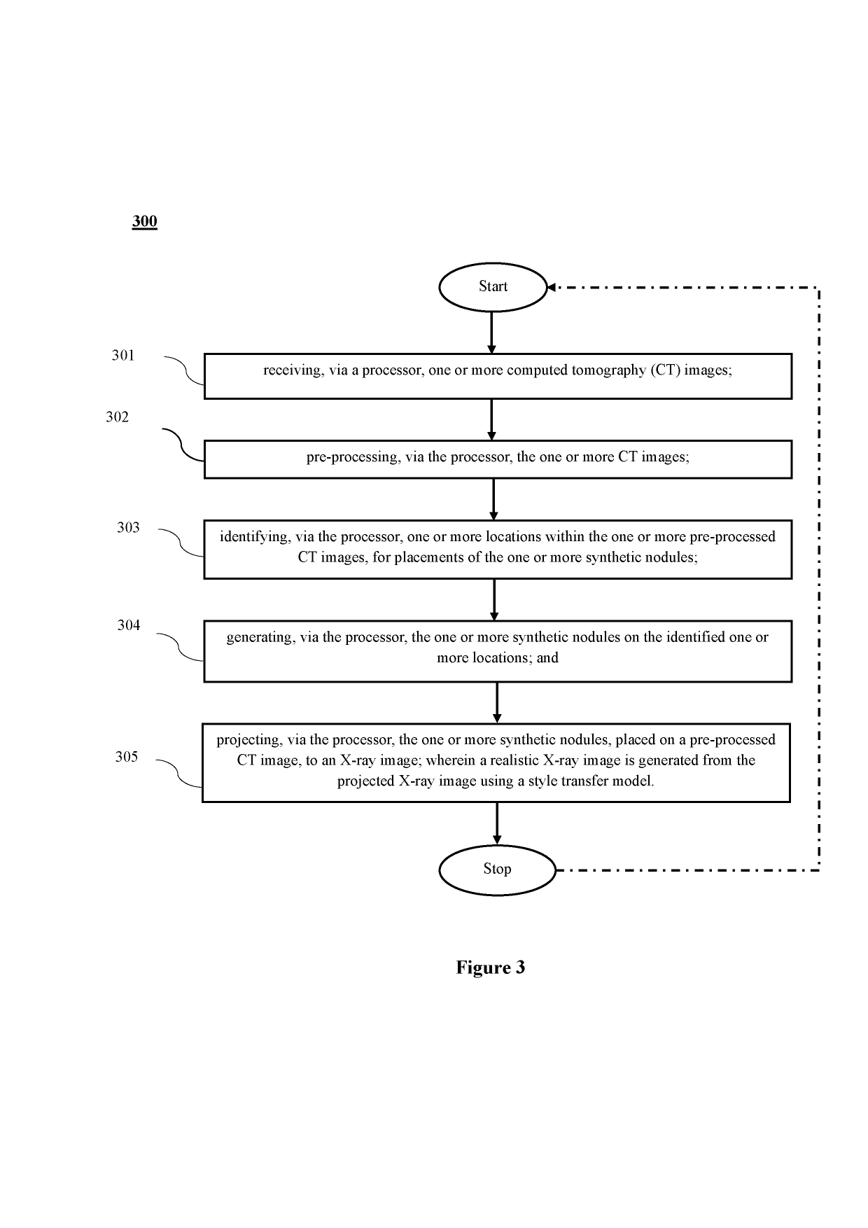

Now referring to FIG. 3, illustrates a flowchart describing a method (300) for projecting the one or more synthetic nodules in the medical imaging, in accordance with at least one embodiment of the present subject matter. The flowchart is described in conjunction with FIGS. 1 and 2. The method (300) starts at step (301) and proceeds to step (305).

In operation, the method (300) may involve a variety of steps, executed by the processor (201), for projecting the one or more synthetic nodules in the medical imaging.

At step (301), the method involves receiving the one or more computed tomography (CT) images.

At step (302), the method involves pre-processing the one or more CT images.

At step (303), the method involves identifying the one or more locations within the one or more pre-processed CT images, for placements of the one or more synthetic nodules.

At step (304), the method involves generating the one or more synthetic nodules on the identified one or more locations.

At step (305), the method involves projecting the one or more synthetic nodules, placed on the pre-processed CT image, to the X-ray image. In an embodiment, the realistic X-ray image is generated from the projected X-ray image using the style transfer model.

Let us delve into a detailed example of the present disclosure.

Imagine the medical imaging system designed to enhance the early-stage cancer detection by generating the synthetic nodules and projecting them onto the X-ray images. This system utilizes a processor to receive and analyze computed tomography (CT) images, identifying suitable locations for synthetic nodule placement. The system ensures anatomical accuracy and clinical realism through a multi-step approach, integrating style transfer techniques to refine the final X-ray representation.

### Working Example

Let’s envision a medical imaging system called "XYZ" designed to simulate and project synthetic nodules onto X-ray images for training deep learning models in lung disease detection.

Suppose a radiology department requires a diverse dataset of X-ray images containing pulmonary nodules for machine learning training. “XYZ” processes high-resolution CT scans by pre-processing them to enhance contrast and reduce noise. The system applies advanced feature extraction techniques to identify suitable lung regions for synthetic nodule placement. Using predefined parameters such as nodule size, shape, texture, and boundary characteristics, “XYZ” generates synthetic nodules and integrates them seamlessly into the CT scan. Once the synthetic nodules are placed, the system projects the modified CT scan into an X-ray image using ray-tracing algorithms that simulate X-ray attenuation through different tissue densities. To ensure clinical realism, the projected X-ray image performs the style transfer technique using a generative model trained on real X-ray images. The style transfer model refines the synthetic image, ensuring that the artificial nodules blend naturally with surrounding lung structures. The resulting X-ray images closely mimic real radiographs, allowing them to be used for diagnostic model training, physician education, and AI-assisted radiology applications. Additionally, the system dynamically adjusts synthetic nodule parameters based on user-defined configurations, ensuring variability across training datasets.

A person skilled in the art will understand that the scope of the disclosure is not limited to scenarios based on the aforementioned factors and using the aforementioned techniques and that the examples provided do not limit the scope of the disclosure.

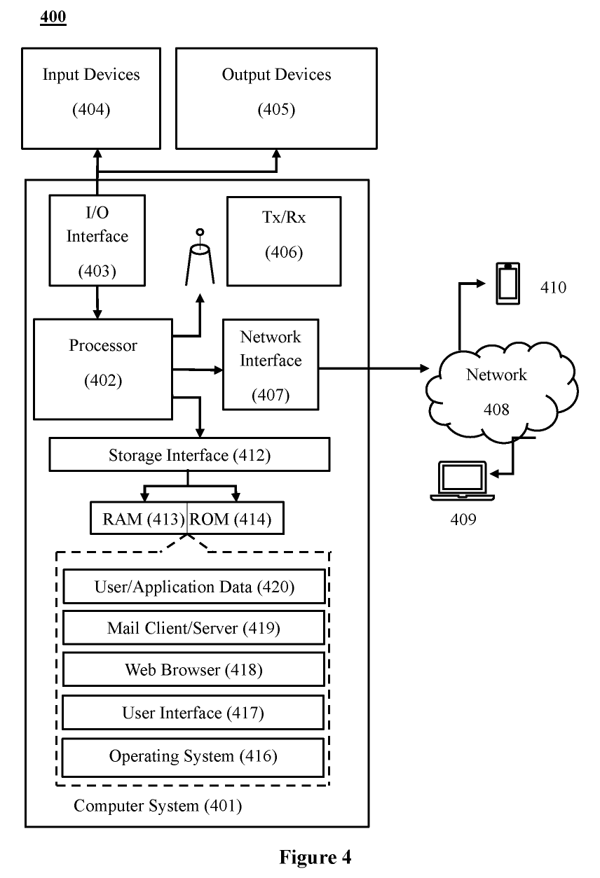

Now referring to FIG. 4, illustrates a block diagram (400) of an exemplary computer system (401) for implementing embodiments consistent with the present disclosure. Variations of computer system (401) may be used as the method for projecting the one or more synthetic nodules in the medical imaging. The computer system (401) may comprise a central processing unit (“CPU” or “processor”) (402). The processor (402) may comprise at least one data processor for executing program components for executing user or system-generated requests. A user may include a person, a person using a device such as those included in this disclosure, or such a device itself. Additionally, the processor (402) may include specialized processing units such as integrated system (bus) controllers, memory management control units, floating point units, graphics processing units, digital signal processing units, or the like. In various implementations the processor (402) may include a microprocessor, such as AMD Athlon, Duron or Opteron, ARM’s application, embedded or secure processors, IBM PowerPC, Intel’s Core, Itanium, Xeon, Celeron or other line of processors, for example. Accordingly, the processor (402) may be implemented using mainframe, distributed processor, multi-core, parallel, grid, or other architectures. Some embodiments may utilize embedded technologies like application-specific integrated circuits (ASICs), digital signal processors (DSPs), or Field Programmable Gate Arrays (FPGAs), for example.

Processor (402) may be disposed in communication with one or more input/output (I/O) devices via I/O interface (403). Accordingly, the I/O interface (403) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMAX, or the like, for example.

Using the I/O interface (403), the computer system (401) may communicate with one or more I/O devices. For example, the input device (404) may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, or visors, for example. Likewise, an output device (405) may be a user’s smartphone, tablet, cell phone, laptop, printer, fax machine, video display (e.g., cathode ray tube (CRT), liquid crystal display (LCD), light- emitting diode (LED), plasma, or the like), or audio speaker, for example. In some embodiments, a transceiver (406) may be disposed in connection with the processor (402). The transceiver (406) may facilitate various types of wireless transmission or reception. For example, the transceiver (406) may include an antenna operatively connected to a transceiver chip (example devices include the Texas Instruments® WiLink WL1283, Broadcom® BCM4750IUB8, Infineon Technologies® X-Gold 618-PMB9800, or the like), providing IEEE 802.11a/b/g/n, Bluetooth, FM, global positioning system (GPS), and/or 2G/3G/5G/6G HSDPA/HSUPA communications, for example.

In some embodiments, the processor (402) may be disposed in communication with a communication network (408) via a network interface (407). The network interface (407) is adapted to communicate with the communication network (408). The network interface, coupled to the processor may be configured to facilitate communication between the system and one or more external devices or networks. The network interface (407) may employ connection protocols including, without limitation, direct connect, Ethernet (e.g., twisted pair 10/100/1000 Base T), transmission control protocol/internet protocol (TCP/IP), token ring, or IEEE 802.11a/b/g/n/x, for example. The communication network (408) may include, without limitation, a direct interconnection, local area network (LAN), wide area network (WAN), wireless network (e.g., using Wireless Application Protocol), or the Internet, for example. Using the network interface (407) and the communication network (408), the computer system (401) may communicate with devices such as shown as a laptop (409) or a mobile/cellular phone (410). Other exemplary devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system (401) may itself embody one or more of these devices.

In some embodiments, the processor (402) may be disposed in communication with one or more memory devices (e.g., RAM 413, ROM 414, etc.) via a storage interface (412). The storage interface (412) may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, or solid-state drives, for example.

The memory devices may store a collection of program or database components, including, without limitation, an operating system (416), user interface application (417), web browser (418), mail client/server (419), user/application data (420) (e.g., any data variables or data records discussed in this disclosure) for example. The operating system (416) may facilitate resource management and operation of the computer system (401). Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

The user interface (417) is for facilitating the display, execution, interaction, manipulation, or operation of program components through textual or graphical facilities. For example, user interfaces may provide computer interaction interface elements on a display system operatively connected to the computer system (401), such as cursors, icons, check boxes, menus, scrollers, windows, or widgets, for example. Graphical user interfaces (GUIs) may be employed, including, without limitation, Apple Macintosh operating systems’ Aqua, IBM OS/2, Microsoft Windows (e.g., Aero, Metro, etc.), Unix X-Windows, or web interface libraries (e.g., ActiveX, Java, JavaScript, AJAX, HTML, Adobe Flash, etc.), for example.

In some embodiments, the computer system (401) may implement a web browser (418) stored program component. The web browser (418) may be a hypertext viewing application, such as Microsoft Internet Explorer, Google Chrome, Mozilla Firefox, Apple Safari, or Microsoft Edge, for example. Secure web browsing may be provided using HTTPS (secure hypertext transport protocol), secure sockets layer (SSL), Transport Layer Security (TLS), or the like. Web browsers may utilize facilities such as AJAX, DHTML, Adobe Flash, JavaScript, Java, or application programming interfaces (APIs), for example. In some embodiments the computer system (401) may implement a mail client/server (419) stored program component. The mail server (419) may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, or WebObjects, for example. The mail server (419) may utilize communication protocols such as internet message access protocol (IMAP), messaging application programming interface (MAPI), Microsoft Exchange, post office protocol (POP), simple mail transfer protocol (SMTP), or the like. In some embodiments, the computer system (401) may implement a mail client (420) stored program component. The mail client (420) may be a mail viewing application, such as Apple Mail, Microsoft Entourage, Microsoft Outlook, or Mozilla Thunderbird.

In some embodiments, the computer system (401) may store user/application data (421), such as the data, variables, records, or the like as described in this disclosure. Such databases may be implemented as fault-tolerant, relational, scalable, secure databases such as Oracle or Sybase, for example. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer- readable medium” should be understood to include tangible items and exclude carrier waves and transient signals, i.e., non-transitory. Examples include Random Access Memory (RAM), Read- Only Memory (ROM), volatile memory, non-volatile memory, hard drives, Compact Disc (CD) ROMs, Digital Video Disc (DVDs), flash drives, disks, and any other known physical storage media.

Various embodiments of the disclosure provide a non-transitory computer readable medium and/or storage medium, and/or a non-transitory machine-readable medium and/or storage medium having stored thereon, a machine code and/or a computer program having at least one code section executable by a machine and/or a computer for projecting the one or more synthetic nodules in the medical imaging. The at least one code section in the application server (101) causes the machine and/or computer including one or more processors to perform the steps, which includes receiving the one or more computed tomography (CT) images. Further, the processor (201) may perform a step of pre-processing the one or more CT images. Further, the processor (201) may perform a step of identifying the one or more locations within the one or more pre-processed CT images, for the placements of the one or more synthetic nodules. Furthermore, the processor (201) may perform a step of generating the one or more synthetic nodules on the identified one or more locations. Moreover, the processor (201) may perform a step of projecting the one or more synthetic nodules, placed on the pre-processed CT image, to the X-ray image. In an embodiment, the realistic X-ray image is generated from the projected X-ray image using the style transfer model.

Various embodiments of the disclosure encompass numerous advantages, including the system and the method for projecting the one or more synthetic nodules in the medical imaging. The disclosed system and the method have several technical advantages, but not limited to the following:

Improved Early-Stage Disease Detection: he system enables the creation of realistic training datasets for machine learning models, improving the detection of early-stage nodules, such as lung cancer, or any lung disease. Further, the system enhances diagnostic accuracy by training AI models with diverse nodule characteristics.

Controlled and Customizable Nodule Generation: The system allows precise control over nodule characteristics (e.g., size, shape, texture, and boundary type). Further, the system facilitates testing and validation of AI models across various medical imaging conditions.

Enhanced AI Training and Generalization: The system reduces data scarcity issues by synthetically generating diverse and labelled training datasets. Further, the system supports domain adaptation by ensuring that synthetic data closely mimics real-world scenarios.

Non-Invasive and Cost-Effective Approach: The system eliminates the need for collecting a large volume of real patient data, reducing reliance on costly and time-consuming medical imaging studies. Further, the system helps in developing AI models without requiring extensive human annotations.

Realistic X-ray Simulation via Style Transfer: The system ensures that projected nodules maintain the realistic appearance of actual medical X- ays. Further, the system enhances the usability of synthetic images for radiologists and AI-based diagnostic tools.

Versatile Applications in Medical Imaging Research: The system is useful for algorithm validation, clinical training, and performance benchmarking of AI-assisted diagnosis systems. Further, system aids in radiologist training by providing a wide variety of synthetic yet realistic case studies.

In summary, the technical problem addressed by the disclosed invention relates to the challenges associated with AI-driven pulmonary nodule detection in the chest X-ray images for the early-stage lung cancer detection. Conventional machine learning models face limitations due to the scarcity of high-quality, annotated datasets, ethical concerns surrounding patient data privacy, and the high cost of manual annotation, leading to inconsistent and non-generalizable training data. Additionally, the inherent constraints of the 2D X-ray imaging, including the loss of depth information, obstruction by overlapping anatomical structures, and low-contrast nodules, result in missed detections and reduced diagnostic accuracy. Furthermore, accurately classifying pulmonary nodules is difficult due to variations in their size, shape, and texture, as well as the challenge of distinguishing malignant formations from benign lesions such as scars or calcifications. These limitations collectively impact the effectiveness of AI-based pulmonary nodule detection systems, leading to increased false positives and false negatives, reduced clinical reliability, and the need for additional diagnostic steps such as CT imaging or biopsy. By introducing the synthetic nodule generation and the projection techniques, along with the style transfer model for the realistic X-ray image generation, the disclosed invention addresses these challenges by augmenting training datasets, improving AI model robustness, and enhancing the accuracy of early-stage lung cancer detection, or any lung disease.

The claimed invention of the system and the method for projecting the one or more synthetic nodules in medical imaging involves tangible components, processes, and functionalities that interact to achieve specific technical outcomes. The system integrates various elements such as processors, memory, databases, one or more processing units comprising deep learning models, the style transfer model, and computational imaging techniques to generate the synthetic nodules, insert the generated synthetic nodules into the CT images, and project the synthetic nodules onto the realistic X-ray images, while maintaining anatomical accuracy.

Furthermore, the invention involves a non-trivial combination of technologies and methodologies that provide a technical solution for a technical problem. While individual components like processors, databases, encryption, authorization and authentication are well-known in the field of computer science, their integration into a comprehensive system for projecting the one or more synthetic nodules in the medical imaging brings about an improvement and technical advancement in the field of medical image processing and other related environments.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that the computer system carries out the methods described herein. The present disclosure may be realized in hardware that includes a portion of an integrated circuit that also performs other functions.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments falling within the scope of the appended claims.

What is claimed is:

1. A method (300) for projecting one or more synthetic nodules in medical imaging, wherein the method (300) comprises:
receiving (301), via a processor (201), one or more computed tomography (CT) images;
pre-processing (302), via the processor (201), the one or more CT images;
identifying (303), via the processor (201), one or more locations within the one or more pre-processed CT images, for placements of the one or more synthetic nodules;
generating (304), via the processor (201), the one or more synthetic nodules on the identified one or more locations; and
projecting (305), via the processor (201), the one or more synthetic nodules, placed on a pre-processed CT image, to an X-ray image;
wherein a realistic X-ray image is generated from the projected X-ray image using a style transfer model.

2. The method (300) as claimed in claim 1, wherein the preprocessing of the one or more CT images is being performed for identifying anatomical body structured from the one or more CT images and eliminating external artefacts from the one or more CT images;
wherein the pre-processing of the one or more CT images is being performed by one or more deep learning techniques;
wherein the one or more deep learning techniques comprises at least one of ResNet encoder, Unet decoder, VGG16/VGG19 Encoder +U-Net Decoder, DenseNet Encoder + U-Net Decoder, MobileNetV2 Encoder + U-Net Decoder, EfficientNet Encoder + U-Net Decoder, HRNet + U-Net Decoder, or a combination thereof;
wherein the one or more deep learning techniques are trained on a plurality of labelled CT scans with annotated lung masks.

3. The method (300) as claimed in claim 2, comprises predicting one or more voxels, from a plurality of voxels of the one or more CT images, by utilizing the one or more deep learning techniques;
wherein each of the one or more voxels is associated with a confidence score indicating probability of each voxel belonging to a lung region in the one or more CT image;
wherein the method (300) comprises converting probability of each voxel from the one or more voxels into a binary mask using one or more image processing techniques;
wherein the one or more image processing techniques comprise at least one of thresholding, morphological operations, Dilation, Erosion, Opening, Closing, Error Correction, or a combination thereof;
wherein the method (300) comprises refining the binary mask, corresponding to each of the one or more voxels, by using the morphological operations;
wherein the method (300) comprises extracting a pair of connected voxels, from the one or more voxels, indicating segmentation of left or right lung.

4. The method (300) as claimed in claim 3, comprises generating a body segmentation mask utilizing the pair of connected voxels;
wherein generating the body segmentation mask comprises iteratively identifying a group of neighbouring voxels from the pair of connected voxels based on at least one of a predefined intensity window, a connection in three-dimension (3D) using kernel, or a combination thereof;
wherein the predefined intensity window corresponds to a window of Hounsfield units ranging from -500 HU to 2000 HU, indicating at least one of soft tissues, bones, or a combination thereof;
wherein the method (300) comprises removing small or disconnected voxels, from the pair of connected voxels, indicating regions outside main body;
wherein the method (300) comprises smoothening edges of the body segmentation mask by using the morphological operations.

5. The method (300) as claimed in claim 4, comprises multiplying the body segmentation mask to original CT image from the one or more CT images, utilizing the one or more deep learning techniques, to retain voxels corresponding to the anatomical body structure and eliminate the external artifacts.

6. The method (300) as claimed in claim 1, wherein identifying the one or more locations corresponds to segmenting each of the one or more pre-processed CT images into one or more regions and generating location proposals based on one or more properties.

7. The method (300) as claimed in claim 6, wherein each synthetic nodule from the one or more synthetic nodules is associated with the one or more parameters; wherein the one or more parameters comprise at least one of texture, shape, nodule boundary or a combination thereof;
wherein the texture parameter within each synthetic nodule is obtained through utilizing one or more noise distribution techniques reflecting real-world nodule patterns;
wherein the texture parameters comprise one of ground-glass (GGN), part-solid, solid, calcified textures, or a combination thereof;
wherein the shape parameter comprises one of spherical, ovoid, linear, elongated, or a combination thereof;
wherein the nodule boundary parameter within each synthetic nodule is obtained through utilizing the one or more image processing techniques;
wherein the nodule boundary parameter comprises at least one of diffused boundary, sharp boundary, spiculated boundary, blending boundary, or a combination thereof.

8. The method (300) as claimed in claim 1, comprises controlling subtlety of the one or more synthetic nodules, wherein the controlling of the subtlety is being controlled using a function of at least one of location, nodule characteristics, radiodensity, or a combination thereof.

9. The method (300) as claimed in claim 1, wherein the projecting of the one or more synthetic nodules to the X-ray image is being performed by using Beer-Lambert Law of attenuation; wherein projecting the one or more synthetic nodules to the X-ray image using the Beer-Lambert Law of attenuation corresponds to generating a Digitally Reconstructed Radiograph (DRR).

10. The method (300) as claimed in claim 1, wherein the style transfer model is configured to enhance diagnostic quality of the projected X-ray image by adjusting one of contrast, brightness, resolution, texture, reduced noise/artifacts or a combination thereof, for generating the realistic X-ray image with preserving critical anatomical details from one of bronchi, small nodules, subtle abnormalities, or a combination thereof.

11. The method (300) as claimed in claim 1, wherein generating of the realistic X-ray image from the projected X-ray image is being performed a denoising diffusion probabilistic model (DDPM) trained on a training data,
wherein generating of the realistic X-ray image comprises post-processing the realistic X-ray image using the style transfer model, for enhancing diagnostic quality and aesthetics the realistic X-ray image by adjusting one of contrast, brightness, resolution, texture, reduced noise/artifacts, or a combination thereof.

12. The method (300) as claimed in claim 11, wherein the training data is prepared using paired high-quality (HQ) real X-rays and low-quality (LQ) CT-to-X-ray projections; wherein the training data is prepared by
utilizing a shared latent space generative adversarial network (GAN) model to transform the DRRs into a high-quality X-ray images;
employing a Multimodal Unsupervised Image-to-Image Translation (MUNIT) architecture to learn the shared latent space between the DRRs and the real X-ray images to allow transformations while maintaining anatomical structure; and
transforming the real X-ray images into DRR-like images, creating a dataset of paired DRR-like images and real X-rays.

13. The method (300) as claimed in claim 1, comprises enhancing quality of the one or more CT images through a super-resolution module, wherein the super-resolution module processes each 2D slice of the received 3D CT image through a trained model to predict an enhanced slice; wherein the method (300) comprises reconstructing complete enhanced 3D CT volume by stacking the enhanced one or more 2D slices.

14. A system (100) for projecting one or more synthetic nodules in medical imaging, wherein the system (100) comprises:
a processor (201);
a memory (202) communicatively coupled with the processor, wherein the memory (202) is configured to store one or more executable instructions that, when executed by the processor (201), cause the processor (201) to:
receive one or more computed tomography (CT) images;
pre-process the one or more CT images;
identify one or more locations within the one or more pre-processed CT images, for placements of the one or more synthetic nodules;
generate the one or more synthetic nodules on the identified one or more locations; and
project the one or more synthetic nodules, placed on a pre-processed CT image, to an X-ray image;
wherein a realistic X-ray image is generated from the projected X-ray image using a style transfer model.

15. A non-transitory computer-readable storage medium having stored thereon, a set of computer-executable instructions that, when executed by a processor (201), cause the processor (201) to perform steps comprising:
receiving one or more computed tomography (CT) images;
preprocessing the one or more CT images;
identifying one or more locations within the one or more pre-processed CT images, for placements of the one or more synthetic nodules;
generating the one or more synthetic nodules on the identified one or more locations; and
projecting the one or more synthetic nodules, placed on a pre-processed CT image, to an X-ray image;
wherein a realistic X-ray image is generated from the projected X-ray image using a style transfer model.
